(19) United States
(12) Patent Application Publication
(10) Pub. No.: US 2021/0174823 A1
(43) Pub. Date: Jun. 10, 2021

(54) System for and Method of Converting Spoken Words and Audio Cues into Spatially Accurate Caption Text for Augmented Reality Glasses

(71) Applicant: Spectrum Accountable Care Company, Las Vegas, NV (US)

(72) Inventors: Barry Goldstein, Las Vegas, NV (US); Quyen Tang Kiet, Huntington Beach, CA (US)

(21) Appl. No.: 16/927,699

(22) Filed: Jul. 13, 2020

Related U.S. Application Data
(60) Provisional application No. 62/945,960, filed on Dec. 10, 2019.

(51) Int. Cl. G10L 21/10; G10L 21/0232; G10L 15/183; H04R 1/40; H04R 3/00; G10L 25/84; G06T 11/60; G09G 5/32; G10L 15/22; G09G 5/02

(52) U.S. Cl. CPC G10L 21/10; G10L 21/0232; G10L 15/183; H04R 1/406; H04R 3/005; G10L 25/84; G10L 2021/065; G09G 5/32; G10L 15/22; G09G 5/02; H04R 2201/401; G09G 2354/00; G06T 11/60

(57) ABSTRACT

A wearable device with augmented reality glasses that allows a user to see the text information and a microphone array that positions the source of sound in three-dimensional space around the user. When the wearable device is worn by a hearing impaired user, the user would be able to see captioned dialogue that is spoken by those around him along with the position information of the speaker.

### RELATED APPLICATION

This application claims is a non-provisional of U.S. Provisional Patent Application 62/945,960, filed on Dec. 1, 2019, for System for and Method of Converting Spoken Words and Audio Cues into Spatially Accurate Caption Text for Augmented Reality Glasses (or “AR glasses”).

### TECHNICAL FIELD

This invention relates to augmented reality apparatus, more specifically, relates to audio captioning and how its visual presentation (in the glasses) of said caption text provides spatial cues to aid the user in identify vicinity and location of the speech, speaker and sound.

### BACKGROUND OF THE INVENTION

Hearing-impaired people often rely on others who know sign language to translate speeches made by people around them. However, there are not too many people who know sign language and this hampers the interaction of the hearing-impaired people with others.

Therefore, there is a need for an apparatus to enable full integration of hearing-impaired people into the current society and it is to this system the present invention is primarily directed to.

### SUMMARY OF THE INVENTION

In one embodiment, the present invention is a method for displaying text on augmented reality glasses with a plurality of microphones. The method comprises capturing audible speech into an audio file from the person speaking, converting said audio file into a text file, determining the position and location of the speaker relative to the individual wearing the augmented reality glasses; if the speaker's position is out of visual range, the text file is displayed with an out of range indicator on the display screen of the augmented reality glasses, and if the speaker's position is within the visual range, the text file is displayed on the screen of the AR glasses adjacent to the position of the speaker on the display screen (close enough to the speaker to identify this individual as the source of the captioned speech).

In another embodiment, the present invention is an augmented reality apparatus for hearing-impaired people. The apparatus comprises a frame, display lens connected to the frame, a plurality of microphones connected to the frame, the plurality of microphones capturing a speech from a nearby speaker, and a controller in communication with the plurality of microphones and the display lens. The controller converts the captured speech into text, calculates a position for the nearby speaker, and displays the text along with contextual information regarding the speaker's relative position on the AR glasses' display lens.

The present system and methods are therefore advantageous to the hearing impaired as they enable speech comprehension during challenging information access circumstances, such as multiple individuals positioned several feet apart while speaking concurrently to said impaired individual. Other advantages and features of the present invention will become apparent after review of the hereinafter set forth Brief Description of the Drawings, Detailed Description of the Invention, and the Claims.

### DESCRIPTION OF THE DRAWINGS

Features and advantages of embodiments of the invention will become apparent as the following detailed description proceeds, and upon reference to the drawings, where like numerals depict like elements, and in which:

FIG. 1 depicts a use scenario 100 of the present invention;

FIG. 2 is an illustration of a wearable device 200 of the present invention;

FIG. 3 depicts a process 300 for capturing speech;

FIG. 4 illustrates a process 400 for calculating the position of a speaker;

FIG. 5 is a schematic diagram 500 for architecture of a controller device; and

FIG. 6 is a process 600 for capturing and translating a speech.

### DETAILED DESCRIPTION OF THE INVENTION

Augmented reality (AR) as defined by Wikipedia is an interactive experience of a real-world environment where the objects that reside in the real world are enhanced by computer-generated perceptual information, sometimes across multiple sensory modalities, including visual, auditory, haptic, somatosensory and olfactory. This invention is an element of AR, in that the “objects” in the real world are human speech (verbal audio) and the enhancement is to place said speech as captioned text visible to the viewer wearing the AR device (glasses, contact lenses, etc.).

The apparatus of the present invention assists individuals with hearing impairment or anybody who is unable to understand what is being said by those around them due to crosstalk and ambient noise.

The apparatus is a wearable device consisting of two parts: (1) AR visual element (for ease of description, it will refer from here on as the “AR glasses”) that allows the user to see the text information (captioned dialogue) and (2) a microphone array that can accurately position the source of sound in three-dimensional space around the user.

When the wearable device is worn by a hearing impaired user, the user would be able to see captioned dialogue that is spoken by those around him in the following manner: (1) all verbal speech is converted to readable text (“captioned dialogue”); (2) the captioned dialogue is visually displayed and positioned below the person who is speaking so that the user is able to identify the source of the speech.

The array of microphones serves as an audio sensor that captures all audible sound, sends the sound data to a processor that filters out noise, identifies individual speech, and calculates the distance and direction from the user to the positional origin of said speech. Once the positional coordinates have been calculated, the processor in the wearable device then converts the speech to text and visibly displays the text in the AR glasses so the user can see which individual is speaking and what is being said.

For example, if Jon is 3 feet to the right of the user and Jon is talking to Jane who is 4 feet to the user's left, the wearable device would collect their conversation, process their speech to text and then display the captioned dialogue directly beneath their relative positions in near real time so that the user can follow the conversation and participate.

Having an array of microphones (properly positioned along the temples to either side of the glasses) can precisely capture the speech taking place around the user and identify each speaker's location in three-dimensional space.

After the location of each speaker is assigned coordinates, the captioned speech is presented as text on the glasses itself (augmented reality) so that the user can read what is being said by each speaker, because the text itself is preferably placed around the relative position of the speaker. Obviously, the exception is taken when the speaker is outside of the user's visual area and this situation will be further discussed later on.

Additionally, as speakers move around the captioned text moves with the speaker because the captioned dialogue will be tracked by the wearable device in real time.

Additionally, speech from the speakers not in view of the user (outside the user's visible viewing angle) but can be sensed by the wearable device will still be captioned and presented in such a way as to signal that dialogue is being spoken behind the user, informing the user to turn his head so that the speakers can become visible and the user would be able to identify who is speaking as the captioned dialogue will be then positioned closest to the speaking source.

Additionally, the user may be able to select and toggle which captioned speech remains visible to reduce the amount of speech traffic taking place around the user, and minimize extraneous information or speech not interesting to the user.

Additionally, the microphones in the array do not have to all be on the user's glasses, they can be in any device worn by the user as long as there are enough microphones to create an array capable of calculating the physical location of speech around the user as described herein.

In one embodiment, the microphone array (4 microphones) would be used and placed around the user (like on the glasses) arrayed in a way that allows for sound source localization so that the subtitles can be properly placed beneath the source of the sound (the speaker).

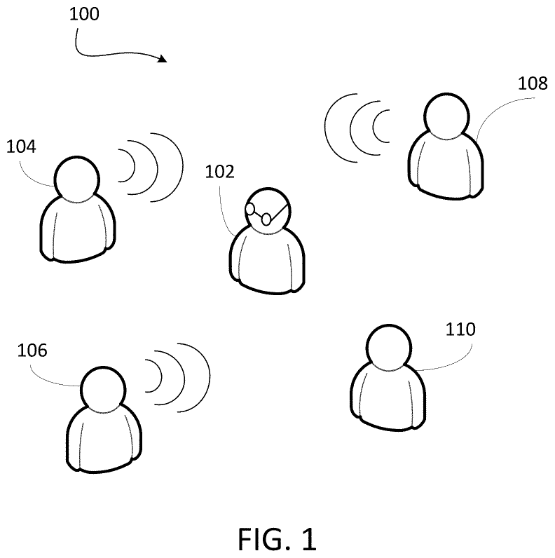

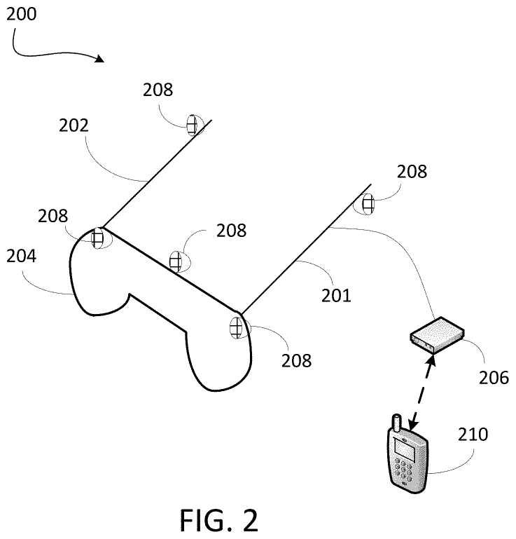

FIG. 1 displays a scenario 100 in which a hearing-impaired user 102 using a wearable device of the present invention in a social setting where he interacts with people around him. The people 104, 106, 108, 110 may be scattered around him and speaking different topics. FIG. 2 is a simple illustration of a wearable device 200. The wearable device 200 may be one AR glasses 202 with a frame 201 and one large display lens 204 and a controller 206. The controller 206 may be physically connected to the AR glasses 202. The AR glasses 202 has a plurality of microphones 208 and these microphones 208 may be distributed around the AR glasses 202. Preferably there will be at least three microphones, so the position of a speaker can be determined easily by triangulation or other suitable methods. The controller 206 may be attached through wires to the AR glasses 202 or wirelessly through Bluetooth waves. The controller 206 may have a user interface to allow the user to control the AR glasses 202. The controller 206 may also be controlled by a remote input device 210. The display lens 204 may be a transparent lens capable of displaying text from the controller 206.

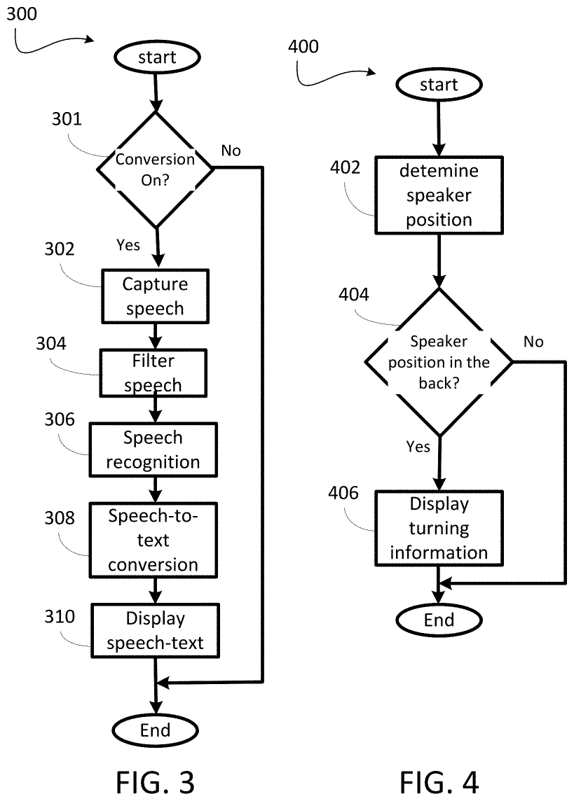

FIG. 3 depicts a process 300 for capturing speech. When a person speaks around the user with the wearable device with microphones, the controller device 206 will check if the audio conversion feature is turned on, step 301. If the audio conversion is turned on, the speech is captured, step 302, and the captured speech is filtered to eliminate noises, step 304. After eliminating the noises, the captured speech is processed for speech recognition, step 306. The speech recognition process may be able to process for one or more languages. The user may be able to set the language preference through the user interface; the user may select two or three languages for translation preference. After the speech recognition, the recognized speech is converted to text, step 308, and displayed by the controller 206 on the AR glasses, step 310. The user will be able to turn of this audio conversion feature.

FIG. 4 illustrates a process 400 for calculating the position of a speaker. The speaker may be located in any direction relative to the user. When the speaker speaks, his speech is captured by at least three microphones and the controller use the timing information from these 3 captured speeches to calculate the relative position of the speaker, step 402. Because of positions of the microphones are known, the position of the speaker can be determined, step 404. If it is determined that the speaker is not in front of the speaker, turning information will be displayed to the user, step 406. The captured speech will be displayed to the user in different color or with some indicator when the speaker is not within the visual range of the user. This means that the text for the speech will be available even if the user does not turn toward the speaker. If the position of the speaker is within the visual range, then text will be displayed normally and adjacent to the position of the speaker in the AR glasses. The visual range setting may be defined as front half of a circle centered around the head of the user; alternatively, the user may also set the visual range covers only a specific angle, for example 60 degrees, around the center of the user's face (30 degrees to each side).

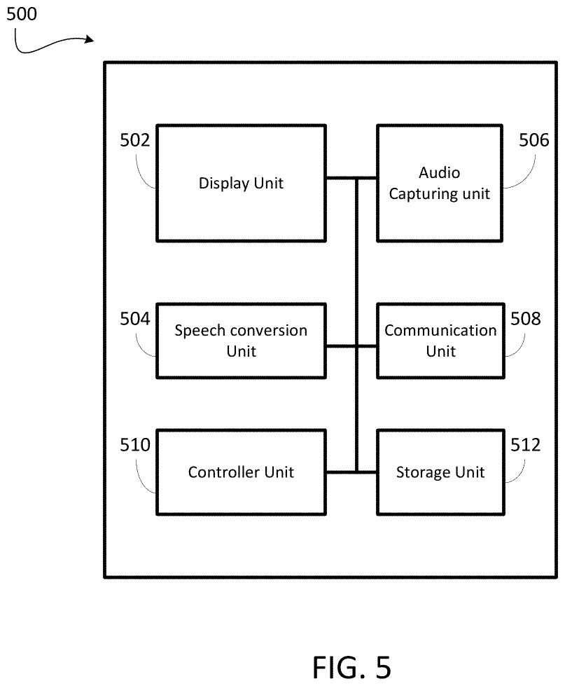

FIG. 5 is a schematic diagram 500 for architecture of a controller device 206. The controller device 206 has a display unit 502, an audio capturing unit 506, a speech conversion unit 504, a communication unit 508, a controller unit 510, and a storage unit 512. The audio capturing unit 506 communicates with the microphones attached to the AR glasses and receive audio input from the microphones. The audio input are captured in audio files and sent to the speech conversion unit 504 for speech-text conversion. As mentioned earlier, the user may set up few prefer languages that the user often hears, so the audio file will be matched against the speech patterns in these preferred languages. In the absence of any preferred language, the audio file will be converted against a default language. The communication unit 508 enables the controller device 206 to communicate with a remote input device 210 and also with the AR glasses if the controller device 206 is not connected to the AR glasses physically. The controller unit 510 controls the operation of the controller device 206 and also calculates the position of the speaker. The text of the captured audio speech and the position information of the speaker are displayed on the display unit 502. The controller unit 510 may also save the audio files and the text files of the converted speeches in the storage unit 512 for later retrieval. The storage unit 512 may also store a user interface menu that allows the user to set up his preferences, such as language preference and also whether to store the audio files and the text files.

The user may connect the controller device 206 with an external computing device, such as a desktop computer, a tablet computer, or a mobile phone through the communication unit 508 and transfer the saved audio files and the text files to the external computing device for storage or play back.

When in use, a hearing-impaired user may wear the AR glasses 202 to a social gathering. At the social gathering, the user may be talking to multiple friends. The speeches from these friends will be captured by the microphones 208 attached to the AR glasses 202 and the speeches will be converted to text in real time and displayed to the user on his AR glasses 202. If someone approaches from behind or anywhere outside of his visual range, the speech will be captured and the position determined. When the text is displayed, the position information of the speaker will also be displayed through either turning information or different text display. If the speaker is within the visual range, then the text is displayed normally without any position information. After returning home, the user may connected his controller device 206 to his computer and download the audio files and text files if he suspects that he may have missed some information spoken by his friends.

The method of the present invention can be performed by a program resident in a computer readable medium, where the program directs a server or other computer device having a computer platform to perform the steps of the method. The computer readable medium can be the memory of the server, or can be in a connective database. Further, the computer readable medium can be in a secondary storage media that is loadable onto a networking computer platform, such as a magnetic disk or tape, optical disk, hard disk, flash memory, or other storage media as is known in the art.

The present invention may also enable the hearing-impaired users to enjoy audio programs transmitted through podcast on the Internet. The controller device 206 may connect to the Internet and download podcast from the desired websites. The audio program will be converted to the text and the text displayed on the AR glasses as described above.

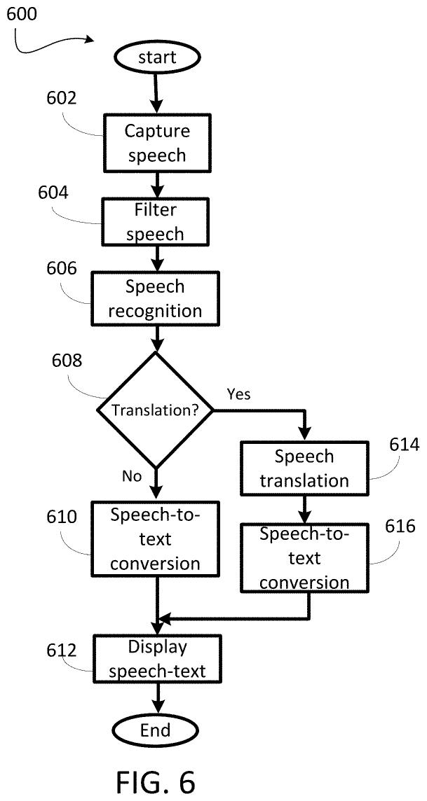

The present invention may further be used to translate a speech in one language into a text in another language, so the user can, not only realize the conversation, but also understand the content when the speech is in a foreign language. FIG. 6 is a process 600 for capturing and translating a speech. The speech is captured into an audio file, step 602, and the noise is filtered out, step 604. The audio file is processed for speech recognition, step 606. The speech is first matched against a default language selected by the user. If the speech is not recognized, step 608, then the speech is translated, step 614. In the translation, the speech recognition is conducted with a secondary language selected by the user and converted to text, step 616. The text file of the speech, whether translated or not, will be displayed on the display area of the AR glasses.

In the context of FIGS. 3-4, the steps illustrated do not require or imply any particular order of actions. The actions may be executed in sequence or in parallel. The method may be implemented, for example, by executing a sequence of machine-readable instructions. The instructions can reside in various types of signal-bearing or data storage media. The media may comprise, for example, RAM, ROM, EPROM, etc. accessible by, or residing within, the components of the network device. The instructions when executed by a computer will enable the computer to perform the steps illustrated in FIGS. 3-4.

While the invention has been particularly shown and described with reference to a preferred embodiment thereof, it will be understood by those skilled in the art that various changes in form and detail may be made without departing from the spirit and scope of the present invention as set forth in the following claims. Furthermore, although elements of the invention may be described or claimed in the singular, the plural is contemplated unless limitation to the singular is explicitly stated. It is foreseeable that different features described in different passages may be combined.

What is claimed is:

1. A method for displaying text on augmented reality glasses with a plurality of microphones, the method comprising:
capturing audio from a speaker into an audio file;
converting the audio file into a text file;
determining a position of the speaker;
if the position is out of a visual range, displaying the text file with an out of range indicator on a display screen of the augmented reality glasses; and
if the position is within the visual range, displaying the text file on the display screen of the augmented reality glasses adjacent to the position of the speaker on the display screen.

2. The method of claim 1, further comprising:
receiving language preference from a user; and
receiving visual range setting from the user.

3. The method of claim 1, further comprising displaying turning information if the position is out of the visual range.

4. The method of claim 1, further comprising checking if audio conversion feature is turned on.

5. The method of claim 1, further comprising storing the audio file and the text file into a storage unit.

6. The method of claim 1, wherein displaying the text file with an out of range indicator on a display screen of the augmented reality glasses further comprising displaying the text file in a different color on a display screen of the augmented reality glasses.

7. The method of claim 1, further comprising filtering out noise from the audio file.

8. The method of claim 1, further comprising translating the audio file into a second language.

9. An augmented reality apparatus for hearing-impaired people comprising:
a frame;
display lens connected to the frame;
a plurality of microphones connected to the frame, the plurality of microphones capturing a speech from a nearby speaker; and
a controller in communication with the plurality of microphones and the display lens,
wherein
the controller converts the captured speech into text, calculates a position for the nearby speaker, and displays the text along with information on the position on the display lens.

10. The augmented reality apparatus of claim 9, wherein the controller receives language preference and visual range setting from a user.

11. The augmented reality apparatus of claim 10, wherein the controller displays turning information if the position is out of the visual range.

12. The augmented reality apparatus of claim 10, wherein the controller displays the text with an out of range indicator on the display lens if the position of the speaker is out of visual range.

13. The augmented reality apparatus of claim 10, wherein the controller displays the text in a different color on the display screen if the position of the speaker is out of visual range.

14. The augmented reality apparatus of claim 9, wherein the controller checks if audio conversion feature is turned on.

15. The augmented reality apparatus of claim 9, wherein the controller stores the speech and the text file a storage unit.

16. The augmented reality apparatus of claim 9, wherein the controller filters out noise from the speech.

17. The augmented reality apparatus of claim 9, wherein the controller translates the speech into a second language.
